(19) United States
(12) Patent Application Publication
(10) Pub. No.: US 2026/0036444 A1
(43) Pub. Date: Feb. 5, 2026

(54) ROTARY OPTICAL ENCODER WITH ROTATING ANGLE-ENCODING LIGHT PATTERN

(71) Applicant: Novanta Corporation, Bedford, MA (US)

(72) Inventors: William G. Thorburn, Danvers, MA (US); Chia-Pin Liang, Wayland, MA (US)

(21) Appl. No.: 19/286,810

(22) Filed: Jul. 31, 2025

Related U.S. Application Data
(60) Provisional application No. 63/679,264, filed on Aug. 5, 2024.
(60) Provisional application No. 63/778,873, filed on Mar. 27, 2025.

(51) Int. Cl. G01D 5/34; G01D 5/347

(52) U.S. Cl. CPC G01D 5/342; G01D 5/3473; G01D 2205/20

(57) ABSTRACT

A rotary optical position encoder includes a source/detector assembly having a source and a detector, the source producing a light beam, the detector receiving the beam with a position-dependent pattern therein and producing position-indicating detector output signals. An optical element is configured for rotation relative to the source and detector, the optical element including an angularly varying optically responsive pattern operative in response to the light beam from the source to produce the position-dependent pattern in the light beam for detection by the detector. The position-dependent pattern has a smoothly varying characteristic as a function of angle, corresponding to the angularly varying optically responsive pattern of the optical element, to emphasize a fundamental component of rotational position in the position-indicating detector output signals.

### CROSS REFERENCE TO RELATED APPLICATIONS

This application is a regular utility application based on earlier-filed U.S. Application No. 63/679,264 filed on Aug. 5, 2024, entitled “ROTARY OPTICAL ENCODER WITH ROTATING ANGLE-ENCODING LIGHT PATTERN”, the contents and teachings of which are hereby incorporated by reference in their entirety.

This application is a regular utility application further based on earlier-filed U.S. Application No. 63/778,873 filed on Mar. 27, 2025, entitled “ROTARY OPTICAL ENCODER WITH ROTATING ANGLE-ENCODING LIGHT PATTERN”, the contents and teachings of which are hereby incorporated by reference in their entirety.

### BACKGROUND

The invention is related to the field of rotary optical position encoders.

### SUMMARY

A rotary optical position encoder includes a source/detector assembly having a source and a detector, the source being configured and operative to produce a light beam, the detector being configured and operative to receive the light beam with a position-dependent pattern therein and produce one or more corresponding position-indicating detector output signal. An optical element is configured for rotation relative to the source and detector, the optical element including an angularly varying optically responsive pattern operative in response to the light beam from the source to produce the position-dependent pattern in the light beam for detection by the detector, the position-dependent pattern having a smoothly varying characteristic as a function of angle, corresponding to the angularly varying optically responsive pattern of the optical element, to emphasize a fundamental component of rotational position in the position-indicating detector output signals.

In examples, the optically responsive pattern is a gradient pattern as may be created using a patterned array of pixels, i.e., small areas of reflective material on a substrate, for example. Reflective arrangements are shown in which the source and detector are substantially co-planar such as on a flat substrate; other arrangements including transmissive arrangements are also provided.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a side schematic depiction of a rotary optical encoder with spatial light pattern;

FIG. 2 is a plan schematic depiction of the rotary optical encoder of FIG. 1;

FIGS. 3 and 4 are example patterns of a rotating optic component to produce a spatial light pattern;

FIG. 5 is a detailed view of a portion of the pattern of FIG. 3, showing detailed structure;

FIGS. 6-8 are side schematic depictions of example rotary encoders using reflective rotating optical components;

FIG. 9 is a more detailed view of the example encoder of FIG. 7;

FIG. 10 is a side schematic depiction of another example rotary optical encoder;

FIG. 11 is a depiction of a light intensity pattern produced in an encoder such as that of FIG. 10;

FIGS. 12-15 are side schematic depictions of example rotary encoders using diffractive rotating optical components;

FIGS. 16-21 are side schematic depictions of example rotary encoders using transmissive rotating optical components;

FIG. 22 is a plan view of a simple 4-channel detector arrangement; and

FIG. 23 is a plan view of an alternative 4-detector arrangement having detector elements spaced apart by unmasked undoped regions to produce a softened response profile (spatial filtering).

### DETAILED DESCRIPTION

### Overview

An optical rotary position encoder is described. It is well suited for a variety of applications where rotary position feedback is required, including but not limited to robotic applications where small size is critical. Many different design variants of this encoder are possible, each with its own cost, size, and performance advantages/disadvantages. Some of these design versions are described below.

The encoder generally includes two subassemblies: a rotating assembly and a stationary assembly. Within the stationary assembly are the light emitting component and the light detecting component, along with analog and digital processing and communication electronics. The primary component of the rotating assembly is an optic. These encoders may be provided as “kit encoders,” i.e., with the two assemblies provided to a system integrator to be integrated into a robot joint, end-effector, or other motion system for minimal size and optimal position sensing accuracy. Wide alignment tolerances of this encoder enable easy installation of this “kit.” The encoder may also be realized as a packaged encoder: fully enclosed with a shaft, bearings, and cover. The design also enables the production of a miniature packaged encoder.

An optical beam is emitted from a light source (e.g., LED or laser (e.g., vertical-cavity surface-emitting laser (VCSEL)). The beam propagates to the optic of the rotating assembly. The optic acts on the beam, causing a spatially varying illumination pattern (nominally ring-shaped) to fall on the detector array (also nominally ring shaped, and typically a photodiode array). The illumination pattern varies spatially, e.g., in a sinusoidal fashion, as a function of angle, to effectively encode angle about a center of the pattern. Rotation of the optic causes rotation of the illumination pattern, which generates correspondingly varying signals (e.g., sinusoidally varying) from a detector array. The detector array typically consists of multiple distinct sectors (e.g., four detectors in respective quadrants, with four signals being generated and taken as 0-, 90-, 180-, and 270-degree phases). These signals are amplified and processed to create differential sine and cosine values and a resultant angle value. As an alternative detector, phototransistors could be used instead of photodiodes.

The encoder, which uses sensors to detect light from a large area of the rotating optical element for spatial averaging, is significantly more immune to contamination-such as dust, scratches, or other imperfections on the optics—than known encoders that may rely on local illumination and detection only. Also, in contrast to the use of linear, stepwise reflectivity in known encoders, the disclosed encoder employs a smoothly varying optical pattern projected onto the sensors enables the processing unit to compute high-resolution angular positions. The non-linear pattern (e.g., sinusoidal pattern), which facilitates common-mode noise rejection (e.g., light source intensity fluctuation) through quadrature detectors, further enhances the encoder's accuracy. The encoder determines angular position using a position-dependent pattern, thereby reducing the manufacturing complexity associated with encoding position through varying detector geometry.

Design versions fall into four main categories based on the optical means by which the illumination pattern is formed by the rotating optic: 1. a reflective/amplitude variant which uses a patterned reflector (mirror) as the optic and forms the sinusoidal illumination on the photodetector array by selective (graded) reflection, 2. a reflective/diffractive variant which uses a diffractive optics to form the structured light in a sinusoidally varying pattern on the photodetector by the optical mechanisms of diffraction and interference, 3. a transmissive/amplitude variant which uses a patterned transmitter as the optic and forms the sinusoidal illumination on the photodetector array by selective (graded) transmission, and 4. a transmissive/diffractive variant which uses a diffractive optics to form the structured light in a sinusoidally varying pattern on the photodetector by the optical mechanisms of diffraction and interference.

In various embodiments, the encoder can be described as a compact, optical, on-axis, absolute, rotary encoder:
Compact: Its diameter and axial dimensions can be made relatively small, making it suitable for applications with closely packed multiple axes for example, especially in configurations where multiple parallel axes are packed into a small area such as for surgical robot end effectors.
Optical: A rotating assembly which includes a reflective/transmissive optic is illuminated by a beam from a laser or LED. The reflected/transmitted beam from the rotating optic returns to the sensor assembly and is incident on a photodetector array with a spatially varying sinusoidal illumination pattern that generates sinusoidally varying current out of each photodiode as the optic assembly is rotated.
On-Axis: Unlike most optical encoders that employ gratings or code disks that are viewed at an off-axis point away from the rotating shaft center, this encoder can operate on-axis, meaning the portion of the rotating optic that is “viewed” is essentially in alignment with (centered on) the rotational axis. The diffractive version of this encoder can also be configured for off-axis operation to accommodate certain application requirements, such as where a thru-hole is required.
Absolute Rotary: The encoder may be configured such that one rotation of the optic rotates a sinusoidal illumination pattern through one full 360-degree rotation, which results in one sinusoidal cycle of variation of each output signal. The signals are in the form of differential analog sine and cosine which are then digitized. Through an interpolation process, these digital signals produce an absolute rotary (angular) position output, i.e., each position throughout one rotation is uniquely identified within the designed resolution. No additional index or home position indicator is needed, and if power goes out, no start-up process to “re-zero” is required.

It should also be mentioned that the subassembly described herein as the rotating assembly could instead be stationary, with the normally stationary part rotating instead. The encoder output is a measure of the angle of rotation of one assembly with respect to the other, regardless of which one is rotating in a system reference frame. Additionally, although a sinusoidally varying illumination pattern is described and may be preferred in many embodiments, patterns varying according to other functions, especially other continuous smooth functions could be used instead.

### Embodiments for Reflective Mode

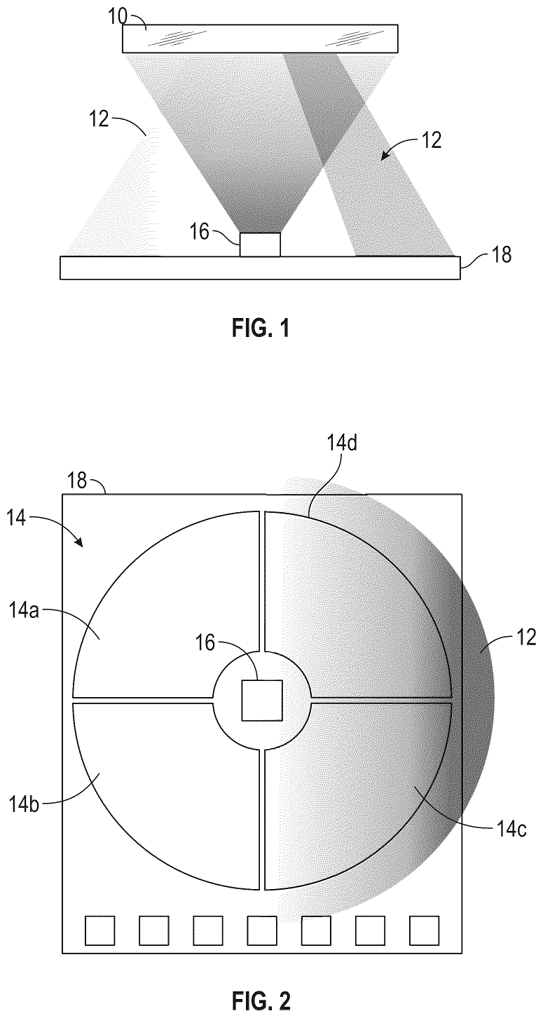

FIGS. 1 and 2 (side and top-down views respectively) depict the reflective amplitude-type variant of a rotary optical encoder (category 1 above) which has an optic 10 in the form of a patterned reflector (mirror) having graded reflectivity which forms the sinusoidal illumination 12 on a photodetector array 14. The source 16 may be realized using a non-coherent light source such as light-emitting diode (LED) or a coherent light source such as a vertical-cavity surface-emitting laser (VCSEL). In the illustrated embodiment, the photodetector array 14 is realized as a 4-element array having elements 14a-14d, which correspond to respective electrical phases 0, 90, 180 and 270 degrees in the associated electrical processing for position identification, as generally known. Also in this reflective embodiment, the source and detector 14 are co-located on the same substrate 18.

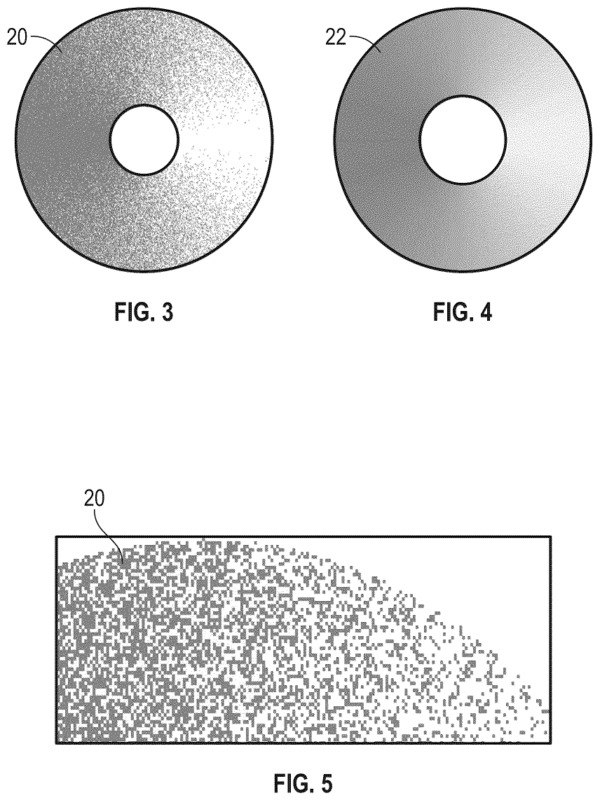

FIGS. 3-5 illustrate example gradient reflector patterns 20, 22 that could be used on the optic 10 to generate the sinusoidal illumination 12. FIG. 3 is an example “pixelized” pattern 20, shown in more detail in FIG. 5.

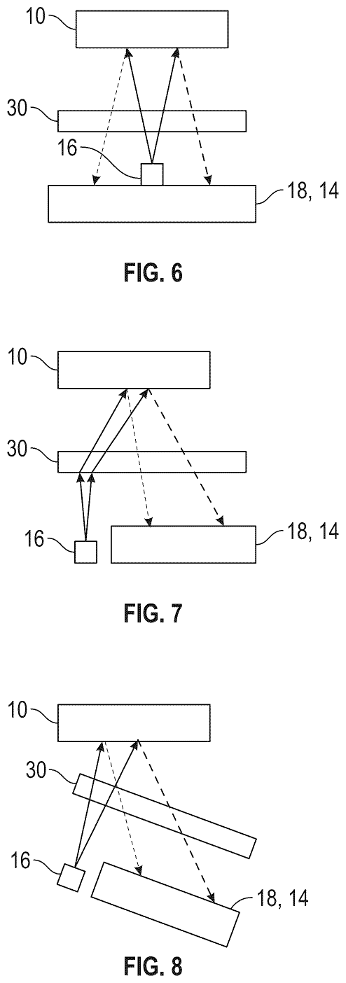

FIGS. 6-8 illustrate alternative configurations:
a. FIG. 6-A coaxial design, suitable for single- and multiple-axis configurations.
b. FIG. 7-A design with beam director function integrated into a window optic 30, also suitable for single- and multiple-axis configurations.
c. FIG. 8-A design with tilted light source and detector assembly. Especially suited for single-axis applications but also usable in multiple-axis configurations.

Either a single light source emitter (e.g., LED or VCSEL) may be used or arrays of multiple light source emitters could be used. The intermediate optic 30 can be a window or it can incorporate beam directing/shaping functions, such as lensing functions that converge, diverge, or shape the beam to distribute light energy over the rotating optic and detector in desired ways (e.g., improved efficiency, signal-to-noise ratio, manufacturability, or alignment tolerances). In some designs the intermediate optic 30 may be omitted. Additional components could be added such as a ball lens on the emitter. Other design configuration variants are also possible.

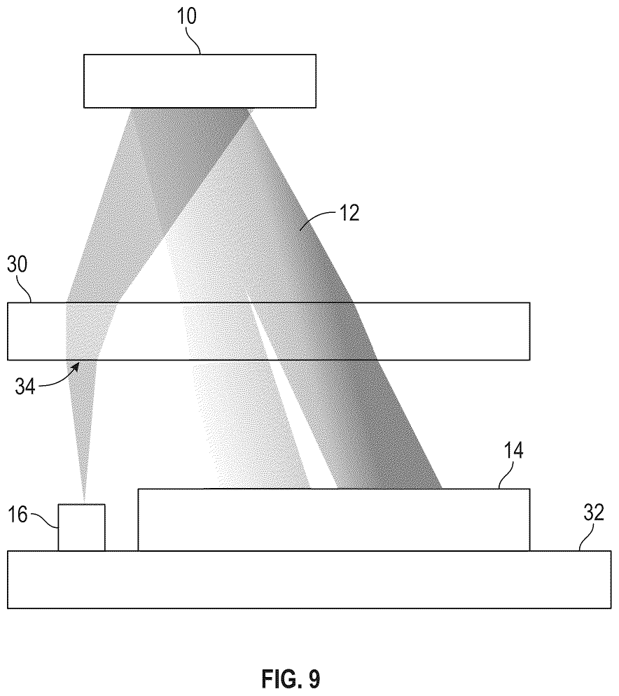

FIG. 9 shows details of a VCSEL/reflective configuration such as that of FIG. 7 (see above), including a VCSEL source 16, window 30, rotating reflective optic 10, and photodetector die 14, which is co-located with source 16 on a printed circuit board (PCB) 32. Graded intensity beam 12 is also shown. A beam director 34 is located on the source side of window 30, which could be multi-level diffractive element or a prismatic refractor.

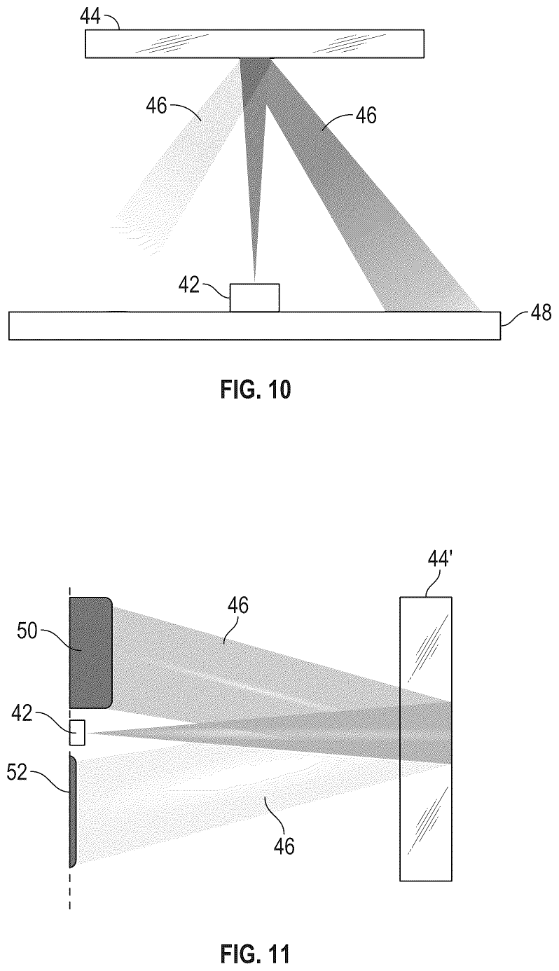

FIGS. 10 and 11 show a reflective/diffractive variant (category 2 above) which uses a diffractive controlled diffuser to form the structured light in a sinusoidally varying pattern on a photodetector by the optical mechanisms of diffraction and interference. This variant includes a coherent light source (VCSEL) 42, optic 44 with controlled diffuser diffractive pattern to generate structured light ring 46 of sinusoidally varying illumination, and a photodetector on a substrate 48 (photodetector not visible in these views) which may be generally similar to the photodetector detector 14 as described above.

FIG. 11 illustrates a cross-sectional view of beam path of a diffractive configuration generally the same as that of FIG. 10, using an optic 44′ that reflects from its far surface rather than its near (source-facing) surface. The dark-shaded areas 50, 52 indicate relative beam intensity at radially opposite locations of the ring of light.

One advantage of diffractive versions such as that of FIGS. 10 and 11 is that they are generally insensitive to lateral misalignment of the rotating optic, i.e., they are relatively tolerant of so-called “radial runout” during operation.

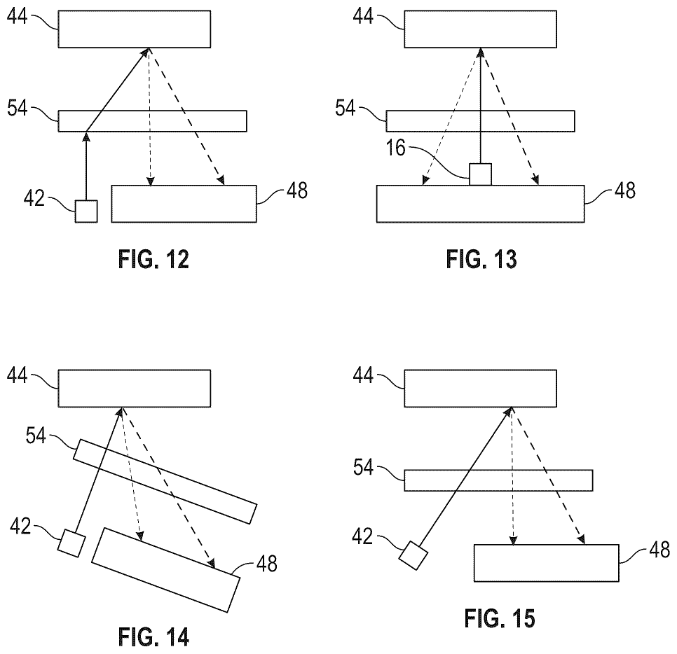

FIGS. 12-15 illustrate alternative reflective/diffractive configurations. Coherent light source (e.g., VCSEL) is commonly used with diffractive optics for optimal optical efficiency.
a. FIG. 12—A design with beam director function integrated into a window optic 54. Suitable for single- and multiple-axis configurations.
b. FIG. 13—A coaxial design, also suitable for single- and multiple-axis configurations.
c. FIG. 14—Sensor assembly (source 42 and photodetector) are tilted relative to rotating diffractive optic 44. Especially suited for single-axis applications but also usable in multiple-axis configurations.
d. FIG. 15—Light source 16 is tilted to direct the beam. Suitable for single-axis and multiple-axis configurations.

### Embodiments for Transmissive Mode

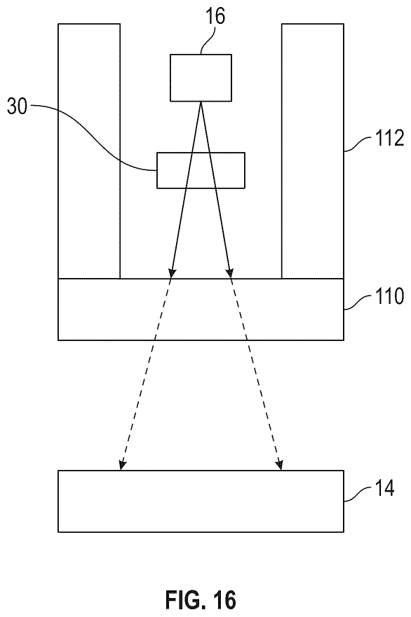

FIGS. 16-18 depict the transmissive, amplitude-type variant of a rotary optical encoder, which includes an optic 110 with patterned transmittance. Light from the source 16 interacts with the optic 110 to generate sinusoidal illumination on a photodetector array (detector 14). The light source 16 may be a non-coherent source, such as an LED, or a coherent source, such as a VCSEL. Light emitted from source 16 may pass through an intermediate optic 30—such as a beam director or a protective window-before interacting with the rotating transmissive optic 110, which may be mounted on a rotating shaft 112 as shown. The graded transmittance of the rotating optic 110 produces position-dependent illumination on the sensor array (detector 14). The sensor array converts the illumination into electrical signals, which are then processed by a processing unit (not shown) to calculate the angular position, as generally known.

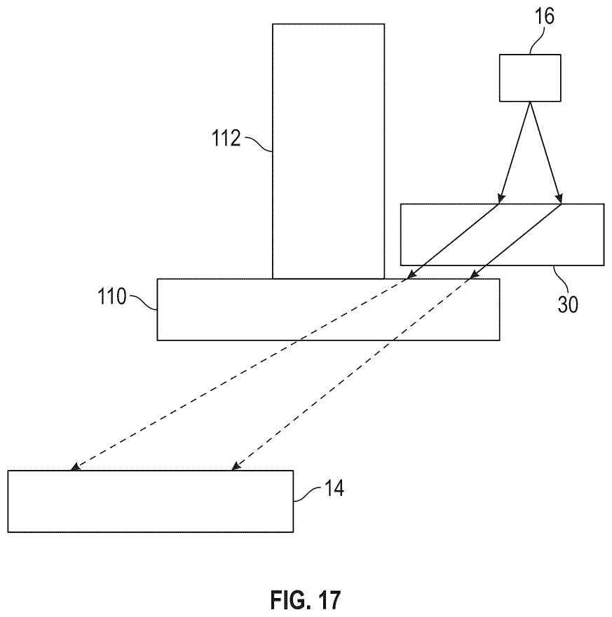

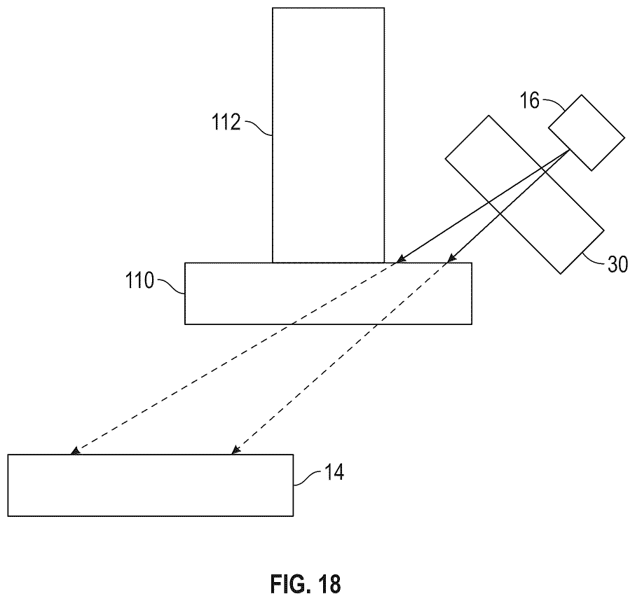

FIGS. 16-18 illustrate the following transmissive configurations:
a. FIG. 16—coaxial design with a thru-hole shaft
b. FIG. 17—a design with beam director function integrated into intermediate optic 30
c. FIG. 18—a design with tilted light source 16.

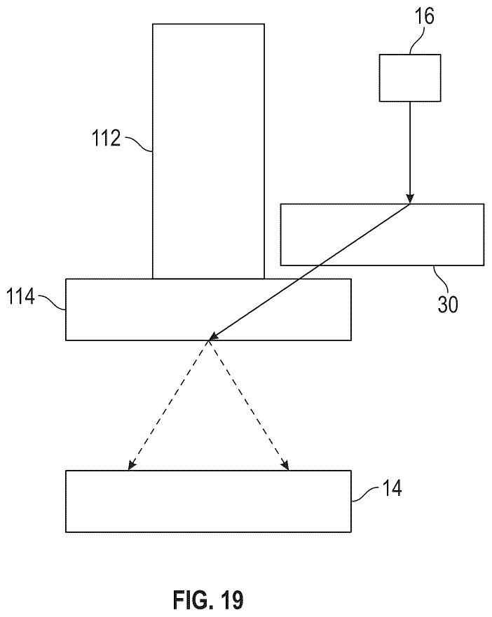

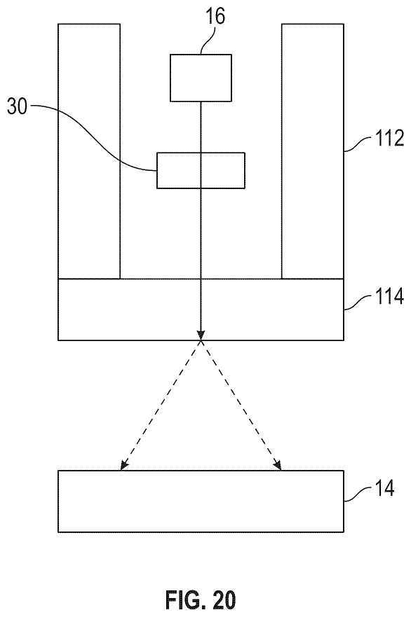

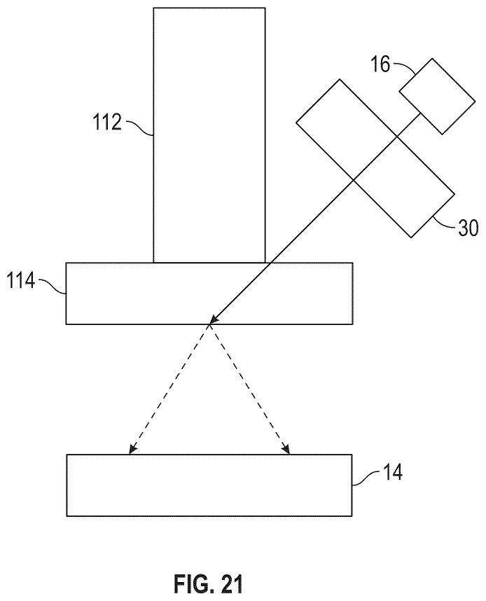

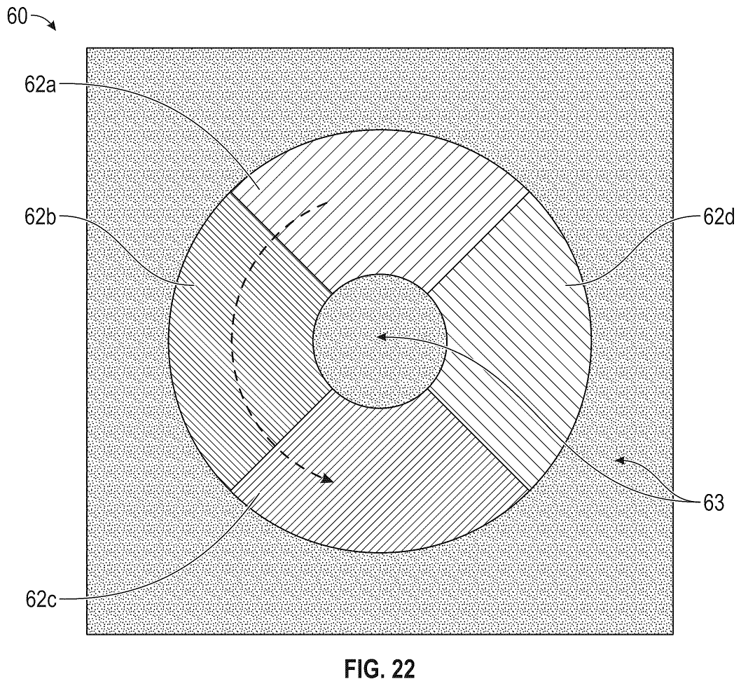

FIGS. 19-21 illustrate alternative transmission/diffractive configurations. The position-dependent pattern is generated by transmissive diffractive optic 114. Coherent light source 16 (e.g., VCSEL) is commonly used with diffractive optics for optimal optical efficiency.
a. FIG. 19—a design with beam director function integrated into intermediate optic 30.
b. FIG. 20—a coaxial design with a thru-hole shaft.
c. FIG. 21—a design with tilted light source 16.

### Details in Various Embodiments

Arrays of multiple light source emitters could be used. The intermediate optic can be a window or it can incorporate beam directing/shaping functions, such as lensing functions that converge, diverge, or shape the beam to distribute light energy over the rotating optic and detector in desired ways (e.g., improved efficiency, signal-to-noise ratio, manufacturability, or alignment tolerances). In some designs the intermediate optic may be omitted. Additional components could be added such as a ball lens on the emitter.

Other specific features/alternatives may include:
a. Illumination that varies sinusoidally with respect to the angle about a center of the pattern;
b. Illumination that varies through one cycle per rotation;
c. Illumination that varies through multiple cycles per rotation;
d. Illumination that is generally annular in its overall shape;
e. Intermediate optics between the light source and rotating optic that shape, direct, obscure, or otherwise alter the beam;
f. Intermediate optics on or around the light source that shape, direct, or otherwise alter the beam;
g. Concentric arrangement of the components;
h. Arrangement of components that creates a non-zero angle of incidence;
i. Light source that is a single mode laser, a multimode laser, a multimode laser with a doughnut shaped beam, an LED, a VCSEL, an edge emitting laser, a light source in die form, a light source consisting of an array of emitters, or a packaged light source;
j. Photodetectors that are photodiodes, phototransistors, discrete photodetectors, photodetectors in array form on a single substrate, photodetectors in a ring-shaped array, or quantity four photodetectors;
k. A rotating optic that is reflective, diffractive, or refractive.

The following are potential options for an Encoder with high coherent or low coherent light source:
a. An optic with a varied reflectivity across its surface (first surface or second surface), the reflectivity gradient varying sinusoidally as a function of the angle about the center of the optic, e.g., bright reflectivity at a 0-deg position, low/minimum reflectivity at 180-deg., partial reflectivity at 90 and 270-deg.
b. Optic source with high or low coherence that is mounted adjacent the detector (with or without beam altering optics, such as divergence decreasing or increasing optics), and the reflected light is incident upon a multi-sector (e.g., 4-sector) photodiode array. The beam altering optic could be in the form of a ball lens, discrete lens, or a diffractive or refractive lens integrated into the optic, for example.
c. Use of a multimode VCSEL which produces a “doughnut” shaped beam, wider in its overall divergence than a single mode VCSEL with a localized power drop in its center for ring-shaped illumination matching the ring-shaped reflective pattern on the optic.
d. Use of a diffuser over the VCSEL to widen its divergence pattern, and by way of scrambling the light, effectively reducing the coherence of the laser beam for minimizing the potential for damaging spatial noise from interference effects within the encoder.
e. Rotation of the optic generates sinusoidally varying signals that are processed in a multi-bin method (e.g., 4-bin) to produce an angular position output.
f. Transmissive instead of reflective.
g. Light source mounted elsewhere than surrounded by the detectors. For example, instead of a coaxial configuration (light source centered on the detector and optic), the light source chip could be positioned to the side with the beam approaching the rotating optic and detector at an angle, perhaps directed that way by a diffractive or refractive optic above the LED/VCSEL.
h. The optic could be made with a varying density/reflectivity chrome pattern, or by varying the spatial density of fully reflective pixels.

The following are potential options for a diffractive-type optical encoder having a high coherence light source (e.g., laser):
a. An optic with a diffractive structure across its surface (first surface or second surface), the diffractive structure being an etched phase structure but could be a replicated or molded structure. This diffractive optic is designed to be a controlled diffuser that, from an incident beam, generates reflected and diffracted structured light in a prescribed plane; that light having the form of an annulus with an illumination gradient varying sinusoidally as a function of the angle measured from the center of the pattern, e.g., bright at 0-deg, dim at 180-deg., medium brightness at 90 and 270-deg. The diffracting pattern may be, for example, a multi-phase structure in the form of cells that are repeated across the surface, so that the same diffraction occurs regardless of which part of the optic is illuminated.
b. The high-coherence light source may preferably be a laser in die form (e.g., VCSEL or EEL), surrounded by the detectors, and the configuration could be coaxial; the light source would be in the center of the detector (i.e., the center of the photodiode array).
c. The back-diffracted light is incident upon a four-sector photodiode array. Rotation of the optic generates four sinusoidally varying signals that are processed in a 4-bin method to produce an angular position output.
d. Other variations such as transmissive not reflective, light source mounted elsewhere than the detector, and coaxial configuration (may be preferred) vs a design with the Light source to the side and the beam approaching the optic and detector at an angle, with or without additional optics.
e. An LED (with a narrow spectral spread) could be used instead of a VCSEL, perhaps using a partially focusing lensing optic to narrow the divergence of the LED.

In addition to the above, other variations include absolute versus incremental versions of the encoder, use of filtering at the detector (such as described below), and certain signal processing features. Filtering at the detector (within the detector) could enhance the encoder accuracy by reducing sensitivity to high spatial frequencies caused by contaminants or defects within the optical path. In this respect, in one embodiment the encoder can utilize a spatial filtering detector from among the examples described below. Signal processing can include application of gain, offset, and phase corrections to the raw detector signals for better accuracy. A look-up table correction could also be performed to improve the position accuracy.

Multi-Element Photodetector with Spatial Filtering

In the encoders described herein, the photodetector is illuminated with an incident beam having a pattern that varies smoothly (e.g., sinusoidally) as a function of angle. As the optic (e.g., optic 10) that generates this shaped illumination is rotated, the pattern rotates in the plane of the detector, and each point on the detector responds to the variation of the local optical flux density as the optic rotates.

Although the illumination pattern is generally smooth (when observed along a circular path) and therefore helps to limit certain error-inducing distortions as described above, there are multiple things that can still limit fidelity, including imperfections in the optic generating the pattern, irregularities in the optical beam emitted from the LED or laser source, and contamination along the entire optical path from the source to the photodetector. These disturbances in the rotating optical pattern result in distortion (and potentially high frequency distortion) of the signals out of the detector, which can result in error in the encoder's final position output signal(s).

Spatial filtering can be used at the photodetector to help minimize the error in the encoder signals. One goal of filtering is to enhance the detector's visibility of the fundamental sinusoidal frequency (e.g., once per revolution) while minimizing its sensitivity to distorting signal components such as harmonics (multiples of fundamental). This can be achieved at least to some extent by designing the detector with softened response at the photodiode edges, and it can ideally be achieved more fully with the photodiode channels having sinusoidal response profiles.

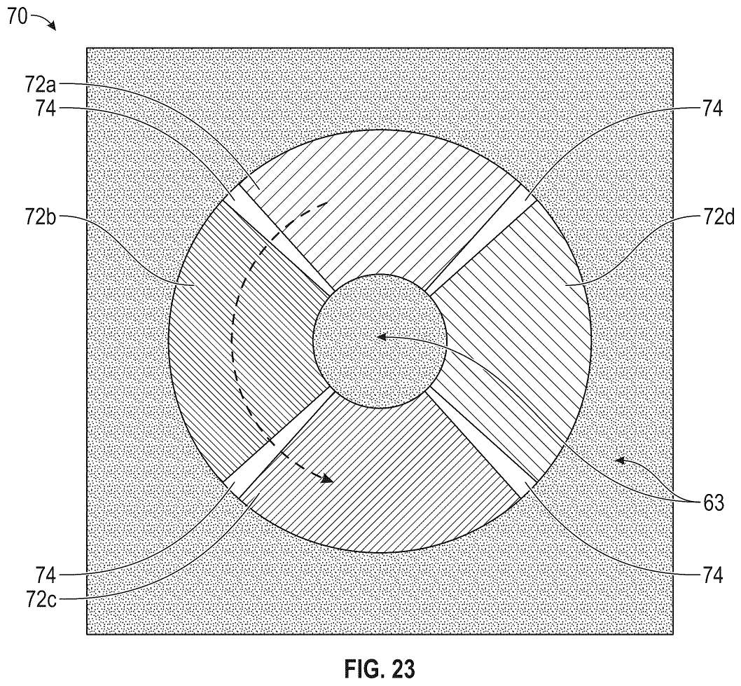

FIG. 22 illustrates a basic 4-segment (4-channel) ring photodetector 60, similar to the photodetector 14 as described above. In this basic configuration, each segment 62a-62d occupies a full 90-degree arc, and there are abrupt transitions between adjacent segments 62. Also indicated are masked areas 63, i.e., areas having an opaque mask covering underlying semiconductor. With this arrangement, the inter-segment transitions are effectively sharp edges at the photodiode segment boundaries that create sensitivity to higher spatial frequencies in the optical pattern, contributing to error/inaccuracy as mentioned above.

FIG. 23 shows an alternative arrangement 70 in which segments 72 are made slightly smaller and are separated by wedge shaped undoped areas 74. This arrangement promotes “crosstalk” between adjacent channels (as described more below) which softens the response profile in these areas. This can help to minimize the detector's sensitivity to high spatial frequencies.

The individual features of the various embodiments, examples, and implementations disclosed within this document can be combined in any desired manner that makes technological sense. Furthermore, the individual features are hereby combined in this manner to form all combinations, permutations, and variants except to the extent that such combinations, permutations, and/or variants have been explicitly excluded or are impractical. Support for such combinations, permutations and variants is considered to exist within this document.

While various embodiments of the invention have been particularly shown and described, it will be understood by those skilled in the art that various changes in form and details may be made therein without departing from the scope of the invention as defined by the appended claims.

What is claimed is:

1. A rotary optical position encoder, comprising:
a source/detector assembly having a source and a detector, the source being configured and operative to produce a light beam, the detector being configured and operative to receive the light beam with a position-dependent pattern therein and produce one or more corresponding position-indicating detector output signals; and
an optical element configured for rotation relative to the source and detector, the optical element including an angularly varying optically responsive pattern operative in response to the light beam from the source to produce the position-dependent pattern in the light beam for detection by the detector, the position-dependent pattern having a smoothly varying characteristic as a function of angle, corresponding to the angularly varying optically responsive pattern of the optical element, to emphasize a fundamental component of rotational position in the position-indicating detector output signals.

2. The rotary optical position encoder of claim 1, wherein the position-dependent pattern is a non-linear pattern.

3. The rotary optical position encoder of claim 2, wherein the position-dependent pattern is a sinusoidal pattern.

4. The rotary optical position encoder of claim 3, wherein the sinusoidal pattern has a period corresponding 1:1 with one period of relative rotation between the optical element and the source/detector assembly.

5. The rotary optical position encoder of claim 1, having a reflective configuration in which (1) the optical element is a reflective element configured to reflect an incident portion of the light beam and produce a reflected portion incident on the detector, and (2) the reflectivity of the optical element is position dependent.

6. The rotary optical position encoder of claim 1, having a reflective configuration in which (1) the optical element is a reflective element configured to reflect an incident portion of the light beam and produce a reflected portion incident on the detector, and (2) the optical element consists of small optical elements with uniform reflectivity. The density of small optical elements which controls the local reflectivity of the optical element is position dependent.

7. The rotary optical position encoder of claim 1, having a reflective/diffractive configuration in which (1) the optical element is a reflective element configured to reflect an incident portion of the light beam and produce a reflected portion incident on the detector, and (2) the optical element produce the position-dependent pattern on detectors by diffractive reflection of the incident portion of the light beam.

8. The rotary optical position encoder of claim 1, having a transmissive configuration in which (1) the optical element is a transmissive element configured to transmit an incident portion of the light beam on the detector, and (2) the transmissivity of the optical element is position dependent.

9. The rotary optical position encoder of claim 1, having a transmissive configuration in which (1) the optical element is a transmissive element configured to transmit an incident portion of the light beam on the detector, and (2) the optical element consists of small optical elements with uniform transmissivity and having a position-varying density providing for local transmissivity of the optical element to be position dependent.

10. The rotary optical position encoder of claim 1, having a transmissive/diffractive configuration in which (1) the optical element is a transmissive element configured to transmit an incident portion of the light beam on the detector, and (2) the optical element produces the position-dependent pattern on detectors by diffractive transmission of the incident portion of the light beam.

11. The rotary optical position encoder of claim 1, wherein the source is coherent light source.

12. The rotary optical position encoder of claim 11, wherein the coherent light source is a semiconductor laser source.

13. The rotary optical position encoder of claim 1, wherein the source is a non-coherent light source.

14. The rotary optical position encoder of claim 13, wherein the non-coherent light source is a light-emitting diode (LED) source.

15. The rotary optical position encoder of claim 1, further including an intermediate optic positioned between the source and the optical element.

16. The rotary optical position encoder of claim 15, wherein the intermediate optic includes a beam-directing window configured to direct the light beam from the source to a predetermined area of the optical element.

17. The rotary optical position encoder of claim 15, wherein the intermediate optic includes a diffuser to reduce speckle noise from the source and/or to widen illumination angle.

18. The rotary optical position encoder of claim 15, wherein the intermediate optic includes a beam shaping optic to distribute light energy over the optical element and the detector in a predetermined manner.

19. The rotary optical position encoder of claim 1, wherein the detector includes one or more photosensitive areas of a detector substrate, the photosensitive areas being exposed to the light beam via respective openings of an opaque mask formed on the detector substrate.

20. The rotary optical position encoder of claim 19, wherein the detector is a multi-element detector and the photosensitive areas are corresponding detector elements, the detector elements being illuminated by respective portions of the light beam and generating respective ones of the detector output signals corresponding to respective distinct phases of the rotation position.

21. The rotary optical position encoder of claim 1, wherein the detector is a spatial filter detector having a configuration providing spatial filtering to further emphasize the fundamental component of rotational position.
